(19) United States
(12) Patent Application Publication
(10) Pub. No.: US 2024/0361462 A1
(43) Pub. Date: Oct. 31, 2024

(54) CHIP BASED LIDAR 3D OBJECT DETECTION SYSTEM AND METHOD

(71) Applicant: Black Sesame Technologies Inc., San Jose, CA (US)

(72) Inventors: Xinrui Zhang, San Jose, CA (US); Lei Zhang, San Jose, CA (US); Qun Gu, San Jose, CA (US)

(21) Appl. No.: 18/140,445

(22) Filed: Apr. 27, 2023

(51) Int. Cl. G01S 17/894; G01S 7/48; G01S 17/86

(52) U.S. Cl. CPC G01S 17/894; G01S 7/4802; G01S 7/4808; G01S 17/86

(57) ABSTRACT

An example method of converting lidar points to a three-dimensional image, including receiving a set of irregular lidar points forming a lidar point cloud, assigning the set of irregular lidar points to a 3D or 2D grid resulting in a set of assigned points, determining a pseudo image based on the set of assigned points resulting in a set of regular pseudo image points, encoding the set of regular pseudo image points including a reflection channel normalization, at least one point decoration and a point feature of the at least one point decoration resulting in a set of high dimension regular features and predicting at least one three-dimensional object utilizing the set of high dimension regular features.

### BACKGROUND

The present invention is related to light detection and ranging object detection system and method that may be performed on a chip.

Light detection and ranging (LIDAR) is an active remote sensing system that measures the time it takes for emitted light to travel to the ground (or some objects) and back by emitting and receiving lasers. The traversal time is used to calculate the distance between the lidar sensor and reflected objects. The distance and laser emitting orientation are converted to (X, Y, Z) 3D coordinates and a reflection intensity channel, which form a representation of a lidar point. A set of lidar points acquired by the lidar sensor within a sweep forms a point cloud. Point clouds contain distance and reflection information of objects resulting in more precise 3D object detection and localization.

Current deep neural network-based 3D detection algorithms rely on complicated point cloud encoding to improve detection accuracy, such as using computation-intensive 3D convolution and customized network structures. Such methods are time consuming, hardware unfriendly, and cannot meet real-time requirements. Such methods project a point cloud into views such as birds-eye-view (BEV) or field-of-view (FOV) but have low detection accuracy. Current computer vision 3D object detection algorithms suffer from low accuracy and poor generalization.

### SUMMARY

An example method of converting lidar points to a three-dimensional image, including receiving a set of irregular lidar points forming a lidar point cloud, assigning the set of irregular lidar points to a 3D grid resulting in a set of assigned points, determining a pseudo image based on the set of assigned points resulting in a set of regular pseudo image points, encoding the set of regular pseudo image points including a reflection channel normalization, at least one point decoration and a point feature of the at least one point decoration resulting in a set of high dimension regular features and predicting at least one three-dimensional object utilizing the set of high dimension regular features.

### DESCRIPTION OF THE DRAWINGS

In the drawings:

FIG. 1 is a first example system diagram in accordance with one embodiment of the present invention;

FIG. 2 is a second example system diagram in accordance with one embodiment of the present invention;

FIG. 3 is an example 3D lidar detection flow in accordance with one embodiment of the present invention;

FIG. 4 is an example of comparison of model performance for different points feature encoding approaches in accordance with one embodiment of the present invention;

FIG. 5 is an example network architecture of the baseline 3D object detection model backbone in accordance with one embodiment of the present invention;

FIG. 6 is an example network architecture of the modified 3D object detection model backbone in accordance with one embodiment of the present invention;

FIG. 7 is an example method of converting lidar points to a three-dimensional image in accordance with one embodiment of the present invention;

FIG. 8 is another example method of converting lidar points to a three-dimensional image in accordance with one embodiment of the present invention; and

FIG. 9 is a further example method of converting lidar points to a three-dimensional image in accordance with one embodiment of the present invention.

### DETAILED DESCRIPTION OF THE INVENTION

The embodiments listed below are written only to illustrate the applications of this system, not to limit the scope. The equivalent form of modifications towards this system shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus may be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

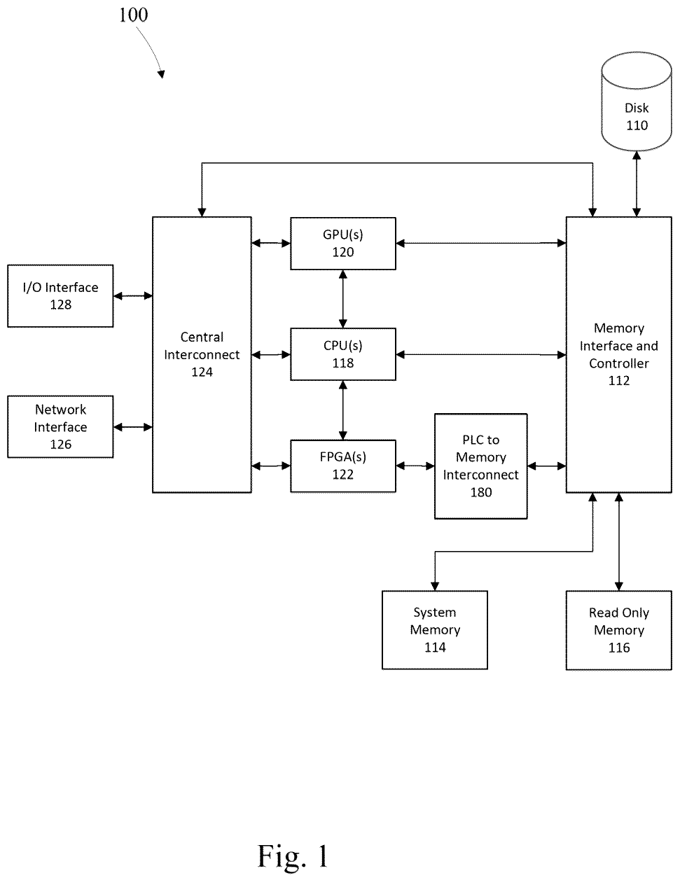

FIG. 1 depicts an example hybrid computational system 100 that may be used to implement coding and decoding associated with the operation of one or more portions or steps of the processes. In this example, the processors associated with the hybrid system comprise a field programmable gate array (FPGA) 122, a graphical processor unit (GPU) 120, and a central processing unit (CPU) 118.

The CPU 118, GPU 120 and FPGA 122 have the capability of providing coding and decoding. A CPU is a general processor that may perform many different functions, its generality leads to the ability to perform multiple different tasks, however, its processing of multiple streams of data is limited and its function with respect to coding and decoding is limited. A GPU is a graphical processor which has many small processing cores capable of processing parallel tasks in sequence. An FPGA is a field programmable device, it has the ability to be reconfigured and perform in hardwired circuit fashion any function that may be programmed into a CPU or GPU. Since the programming of an FPGA is in circuit form, its speed is many times faster than a CPU and appreciably faster than a GPU.

There are other types of processors that the system may encompass such as an accelerated processing unit (APUs) which comprise a CPU with GPU elements on chip and digital signal processors (DSPs) which are designed for performing high speed numerical data processing. Application specific integrated circuits (ASICs) may also perform the hardwired functions of an FPGA; however, the lead time to design and produce an ASIC is on the order of quarters of a year, not the quick turn-around implementation that is available in programming an FPGA.

The graphical processor unit 120, central processing unit 118, and field programmable gate arrays 122 are connected to a memory interface controller 112. The FPGA is connected to the memory interface through a programmable logic circuit to memory interconnect 130. This additional device is utilized due to the fact that the FPGA is operating with a very large bandwidth and to minimize the circuitry utilized from the FPGA to perform memory tasks. The memory and interface controller 112 is additionally connected to persistent memory disk 110, system memory 114, and read only memory (ROM) 116.

The system may be utilized for programming and training the FPGA. The GPU functions well with unstructured data and may be utilized for training. Once the data has been trained a deterministic inference model may be found and the CPU may program the FPGA with the model data determined by the GPU.

The memory interface and controller are connected to a central interconnect 124. The central interconnect is additionally connected to the GPU 120, CPU 118 and FPGA 122. The central interconnect 124 is additionally connected to the input and output interface 128 and the network interface 126.

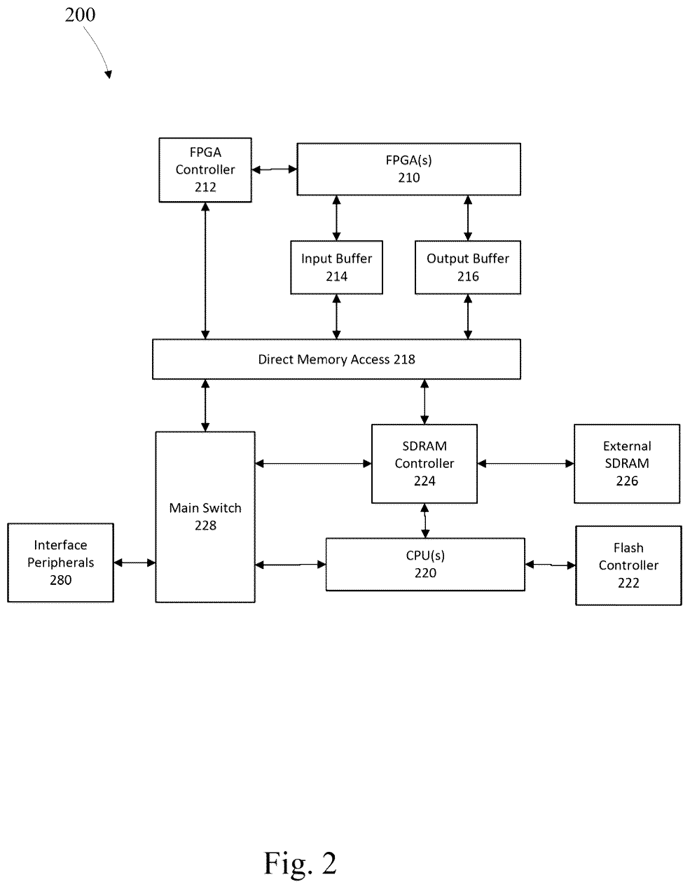

FIG. 2 depicts a second example hybrid computational system 200 that may be used to implement coding and decoding associated with the operation of one or more portions or steps of process 1000. In this example, the processors associated with the hybrid system comprise a field programmable gate array (FPGA) 210 and a central processing unit (CPU) 220.

The FPGA is electrically connected to an FPGA controller 212 which interfaces with a direct memory access (DMA) 218. The DMA is connected to input buffer 214 and output buffer 216, which are coupled to the FPGA to buffer data into and out of the FPGA respectively. The DMA 218 includes of two first in first out (FIFO) buffers one for the host CPU and the other for the FPGA, the DMA allows data to be written to and read from the appropriate buffer.

On the CPU side of the DMA are a main switch 228 which shuttles data and commands to the DMA. The DMA is also connected to an SDRAM controller 224 which allows data to be shuttled to and from the FPGA to the CPU 220, the SDRAM controller is also connected to external SDRAM 226 and the CPU 220. The main switch 228 is connected to the peripherals interface 230. A flash controller 222 controls persistent memory and is connected to the CPU 220.

The present invention can detect 3D objects from lidar point clouds utilizing a system-on-chip (SOC). In one example, an irregular point cloud of lidar points is input using a preprocessor and a postprocessor in which redundant operators have been removed and where the received irregular point cloud input is transferred to a regular BEV pseudo image by assigning the irregular points to a 3D BEV grid. Additionally, the network utilizes points decoration, reflection channel normalization, and point feature encoding to improve the model's performance and enable quantization of the neural network and encode the normalized pseudo image input for 3D object detection. Points decoration adds an offset to detected points. Reflection channel normalization normalizes the size of points in a point cloud to give the points a normalized scale. Point feature encoding fuses features of different levels. Quantization aware training (QAT) converts a float model trained with float values to a fixed-point integer model. The QAT allows recovery of the accuracy drop during the quantization process. These modifications allow a simplified deep neural network to be run on a SOC.

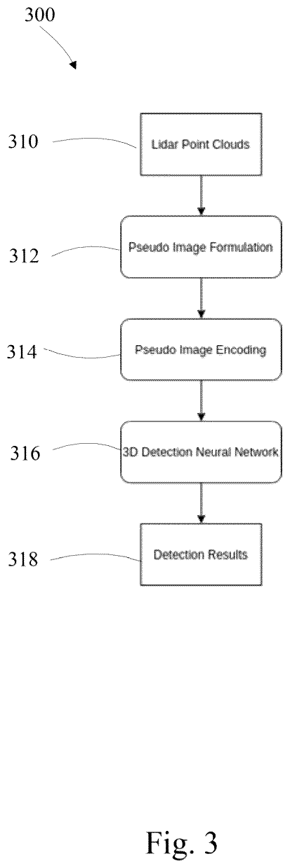

FIG. 3 depicts an example 3D lidar detection system receives 310 a set of irregular lidar points forming Lidar point clouds, transforms 312 the set of irregular lidar points into a set of regular pseudo image points forming a pseudo image (such as BEV pseudo image), encodes 314 the set of regular pseudo image points into a set of high dimension regular features, and feeds 316 the set of high dimension regular features into a neural network to detect 318 3D objects.

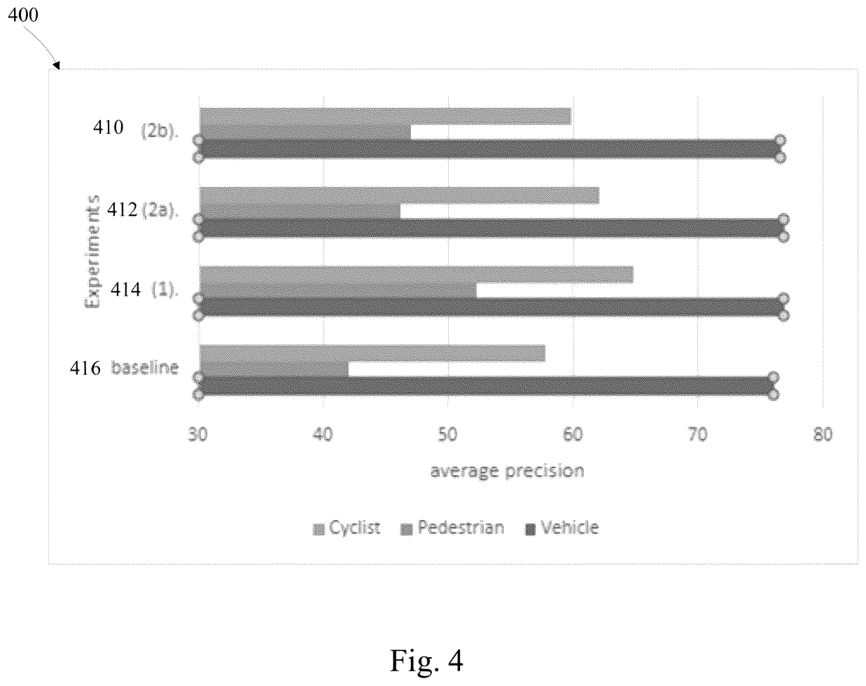

FIG. 4 depicts model performance for different points feature encoding approaches. In model (1) 414, a standalone encoder contains two operators: matrix multiplication and max pooling. The encoder transforms decorated points input to higher dimension features and applies global max pooling on points dimension to generate encoded features. Model (2a) 412 utilizes a fused encode having two cascade convolutional layers with an inverted bottleneck. Model (2b) 414 utilizes a fused encoder with an extra spatial attention branch. The baseline performance is shown as 416.

In pseudo image formation, the lidar point cloud is filtered by a predefined detection range according to spatial coordinates and redundant points are suppressed. Optionally, filtered points are further limited within a FOV (field of view) by rectification, which transforms the lidar points from 3D lidar coordinates to 3D camera coordinates and determines 2D point coordinates on an image plane by projecting 3D coordinates into 2D. A BEV pseudo image is defined by splitting the detection range by predefined rectangle grids in the X, Y axes. The shapes of the grids are consistent and have a fixed number of points. The BEV pseudo image is filled with the lidar points according to a grid range. If there are not enough points for a grid, the grid points are filled by zeros.

In one example of pseudo image formation, the lidar point cloud is filtered by a predefined detection range according to spatial coordinates and redundant points are suppressed. A BEV pseudo image is defined by splitting the detection range by predefined rectangle grids in the X, Y axes. The BEV pseudo image is filled with the lidar points according to a grid range. If there are not enough points for a grid, the grid points are filled by zeros.

In another example of pseudo image formation, the lidar point cloud is filtered by a predefined detection range according to spatial coordinates thereby obtaining first-filtered points, and redundant points are suppressed. First-filtered points are further limited within FOV (field of view) by a rectification process, wherein the rectification process includes transforming first-filtered lidar points from lidar coordinates (3D coordinates) to camera coordinates (3D coordinates); projecting camera coordinates to image plane/BEV plane thereby obtaining 2D points on the image plane; selecting 2D points within FOV (since the detection area of the lidar is usually larger than the detection area of a camera, therefore, FOV can be used to further limit the amount/scope of lidar points which will be used to form a BEV image); obtaining first-filtered lidar points corresponding to those 2D points within FOV, thereby obtaining second-filtered lidar points. A BEV pseudo image is defined by splitting the detection range by predefined rectangle grids in the X, Y axes. The BEV pseudo image is filled with second-filtered lidar points according to a grid range. If there are not enough points for a grid, the grid points are filled by zeros.

In pseudo image encoding, the pseudo image is encoded via a three step procedure: normalizing a reflection channel, decorating points, and encoding points as features.

Reflection channel normalization normalizes the size of points in a point cloud to give the points a normalized scale. The reflection channel range of most lidar sensors is from 0 to 255, the reflection channel needs to be normalized to [−1,1] range by subtracting 128 and dividing 255, which is utilized in quantization aware training (QAT).

Points decoration adds an offset to detected points. A pseudo image is a collection of raw lidar data points. There are at least two approaches to decorate points. In one example, points in the 3D grid are subtracted by the grid center coordinates and the normalized reflection channel is also kept. The raw points input (X, Y, Z, reflection) are transformed to decorated points input (X-grid X, Y-grid Y, Z-grid Z, reflection). In another example, points in the grid are not only subtracted by grid center coordinates but also subtracted by points' centroid in the grid. The decorated input will be raw points (X, Y, Z, reflection), points subtracting center (X-grid X, Y-grid Y, Z-grid Z), points subtracting centroid (X-centroid X, Y-centroid Y, Z-centroid Z). The examples appear to outperform the raw points input baseline. The first example may consume less memory and may be more friendly for quantization aware training.

Point feature encoding fuses the features of different levels where decorated points are encoded into high dimension feature space. Two examples of point feature encoding include a standalone module of the system, and the other is fusing the encoder into the neural network backbone. In the first example, the standalone encoder contains two operators: matrix multiplication and max pooling. The encoder transforms decorated points into higher dimension features and applies global max pooling on points dimension to generate encoded features. In the second example in which fusing of the encoder in the neural network backbone, the fused encode may either include two cascade convolution layers with an inverted bottleneck manner or an additional spatial attention branch.

Compared with a set of decorated points utilized as an input baseline, model accuracies may be improved by the encoders. Moreover, encoders may lead to a higher efficiency training process, leading to reduced variance of repeated experiments. Comparing the two encoding approaches, the stand-alone encoder may exhibit enhanced performance while the fused encoders may prove to be more hardware-friendly and efficient since operators in fused encoders have better support than operators in the standalone encoder.

3D object detection in a deep neural network is one in which the encoded pseudo image is fed into a 3D object detection network for generating predictions with 3D object class, size and bearing angle information. The network predictions may be decoded with predefined anchors.

Predefining anchors are a collection of prior 3D boxes with location, size and bearing angle information. Anchors are defined based on object size clusters over the training set. The regression targets may be parameterized offsets of the predefined anchors, leading to network predictions decoded according to predefined anchors.

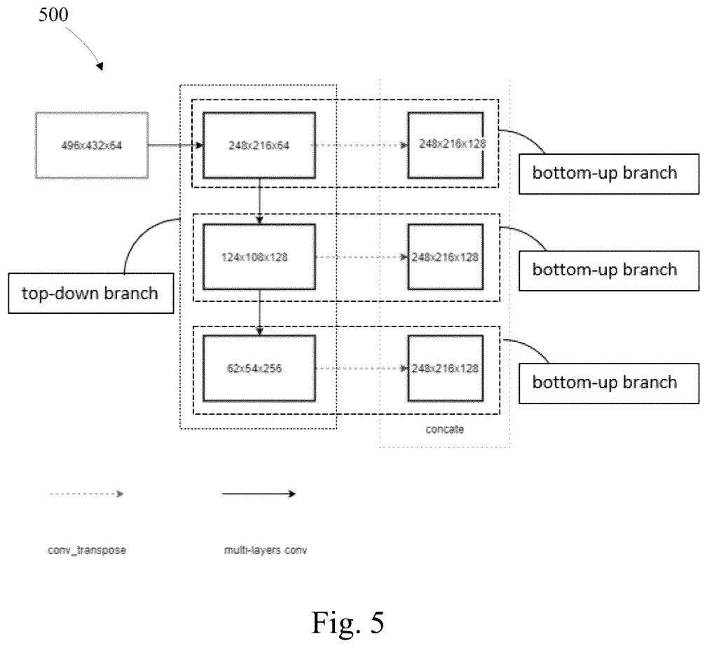

FIG. 5 500 depicts the baseline model's backbone having two branches. The top-down branch produces three feature maps by cascaded neural networks blocks, which contain several convolution layers, batchnorm and Relu combinations. And the bottom-up branch performs upsampling, which is implemented by convtranspose operator and concatenation on the feature maps.

The baseline model's backbone has two branches. The top-down branch produces three feature maps by cascaded neural networks blocks, which contain several convolution layers, batchnorm and ReLu combinations. ReLu is a non-linear activation function utilized in deep neural networks. Batch normalization, batchnorm, normalizes input layers by re-centering and re-scaling. The bottom-up branch performs upsampling, which is implemented by convtranspose operator and concatenation on the feature maps to formulate a final feature map with rich, multi-scale information. Upsampling a sequence of samples determines an approximation of the sequence that would have been obtained by sampling the signal at a higher rate. A deconvolutional layer reverses the operation of a typical convolutional layer. The transposed convolutional layer, convtranspose is like the deconvolutional layer in that the spatial dimension generated by them are the same. A transposed convolution reverses the typical convolution by dimensions.

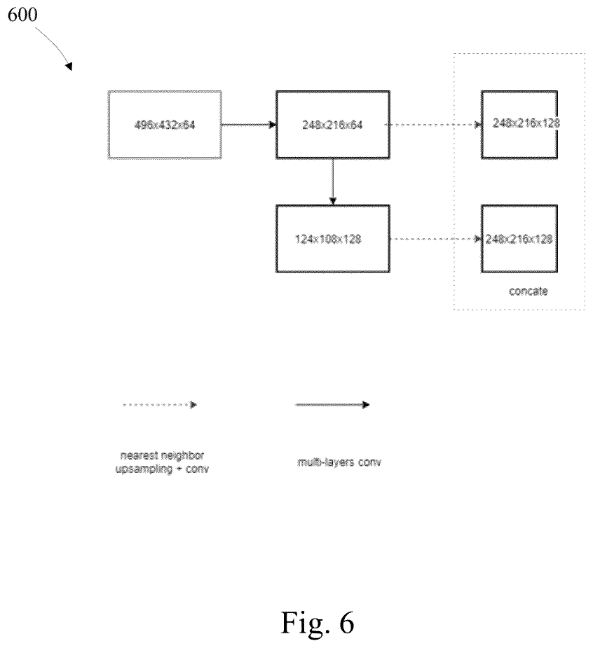

FIG. 6 600 depicts a modification to the baseline model backbone structure based on experimental results. In one example the last conv block in the top-down and bottom-up branches are removed. The computation cost may be reduced to half of the baseline model, without a significant loss of accuracy. In one example the convtranspose operator for upsampling in bottom-up branch is replaced with a combination of nearest neighbor upsampling and convolution operator to overcome checkerboard artifacts. A concatenated feature map generates predictions utilizing convolutional heads such as the classification head, regression head and direction (bearing angle) head on concatenated feature map to generate predictions.

Operators in the neural network are utilized for the SOC chip. The detection system runs in real-time, which means the computation cost of the network needs to be minimized. The SOC chip implements integer operators, so the neural network utilized quantized integers.

The preprocessor and postprocessor minimize the number of operations in a single inference cycle and utilizes multithreading for further acceleration.

The neural network quantized model executes operations with integers rather than floating point values to meet SOC hardware specifications. The model is trained in float32 and converted to int8. Native conversion processes often degrade model performance. We applied quantization aware training (QAT) in the forward and backward passes using fake-quantization modules to recover the performance gap between floating point model and integer model.

The reflection channel normalization and points decoration are utilized by the QAT, tensor input channel values are restricted to [−1, 1] range, which is utilized in the quantization process due to limited data representation capability of quantized model.

Data augmentation is utilized in training to maintain model performance. A database is created to hold ground truth 3D boxes and corresponding lidar points for different classes and augment examples from the database to the input point cloud during training, and ground truth boxes used for training are individually augmented, which are applied rotation, translation, and scaling. Random flipping and translation are utilized to simulate localization noise.

The neural network is specially designed for the SOC chip, includes fused feature encoder and modified backbone structure which has been explained in previous sections. The tailored network only takes less than 15 ms to efficiently run on our SOC chip.

Operations of preprocessor and postprocessor are carefully assigned and implemented by high performance libraries, which minimizes the number of operations in a single inference cycle. On top of this, multithreading is employed for further acceleration. After optimization, the preprocessing and postprocessing time is six times faster than the unoptimized version.

Both preprocessing and post processing use high performance libraries to accelerate operators and carefully choose the order of steps to remove operators. In preprocessing, filter points in detection range then limit points within FOV is functionally identical to limit points within FOV and filter points in detection range. However, the overall operators are significantly different because matrix multiplication in limiting FOV needs much more operations than simple comparing points location with detection range. In postprocessing, dequantization and decoding operations are required for every anchor (translate anchor and network output as final 3d detections). Score filtering can be applied first, which reduce 3D detection candidates from 321408 to approximately 200 to be dequantized and decoded.

In preprocessing, matrix operations can further be replaced (project to image plane) by compute angle of all points within range, which is 20× faster. In postprocessing, sigmoid is required to compute confidence scores for filtering. Filtering can be computed threshold by inverse sigmoid once rather apply sigmoid on every candidate (321408 candidates for a typical case).

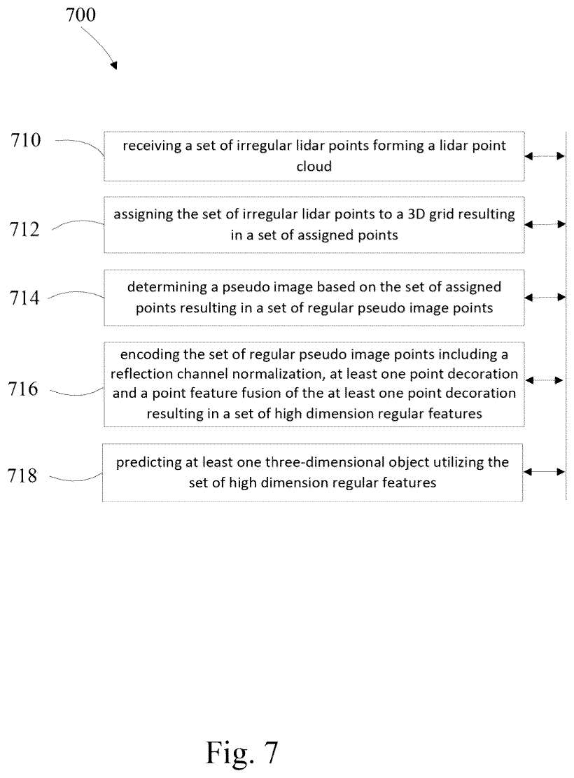

FIG. 7 700 depicts an example method of converting lidar points to a three-dimensional image, including receiving 710 a set of irregular lidar points forming a lidar point cloud, assigning 712 the set of irregular lidar points to a 3D grid resulting in a set of assigned points, determining 714 a pseudo image based on the set of assigned points resulting in a set of regular pseudo image points, encoding 716 the set of regular pseudo image points including a reflection channel normalization, at least one point decoration and a point feature of the at least one point decoration resulting in a set of high dimension regular features and predicting 718 at least one three-dimensional object utilizing the set of high dimension regular features.

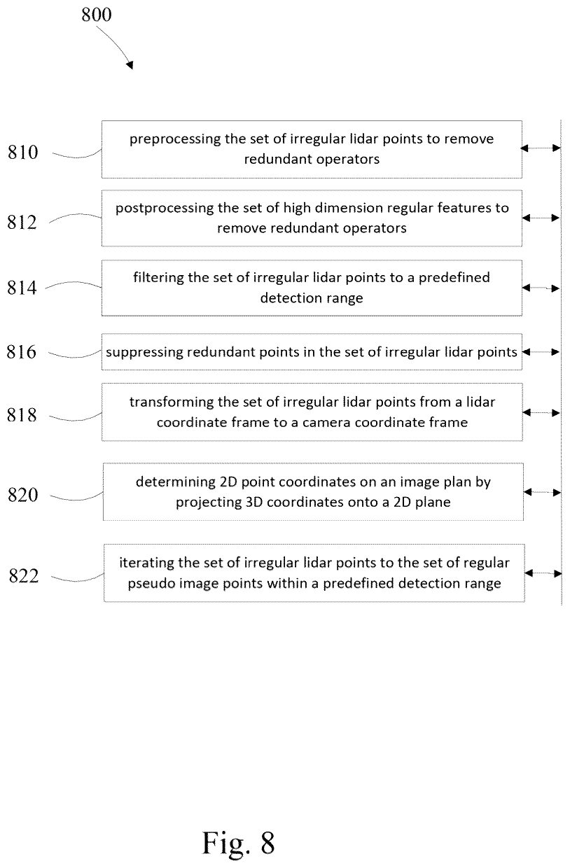

FIG. 8 800 depicts that the method may also include preprocessing 810 the set of irregular lidar points to remove redundant operators, postprocessing 812 the set of high dimension regular features to remove redundant operators and filtering 814 the set of irregular lidar points to a predefined detection range. The example method may further include suppressing 816 redundant points in the set of irregular lidar points, transforming 818 the set of irregular lidar points from a lidar coordinate frame to a camera coordinate frame, determining 820 2D point coordinates on an image plan by projecting 3D coordinates onto a 2D plane and iterating 822 the set of irregular lidar points to the set of regular pseudo image points within a predefined detection range.

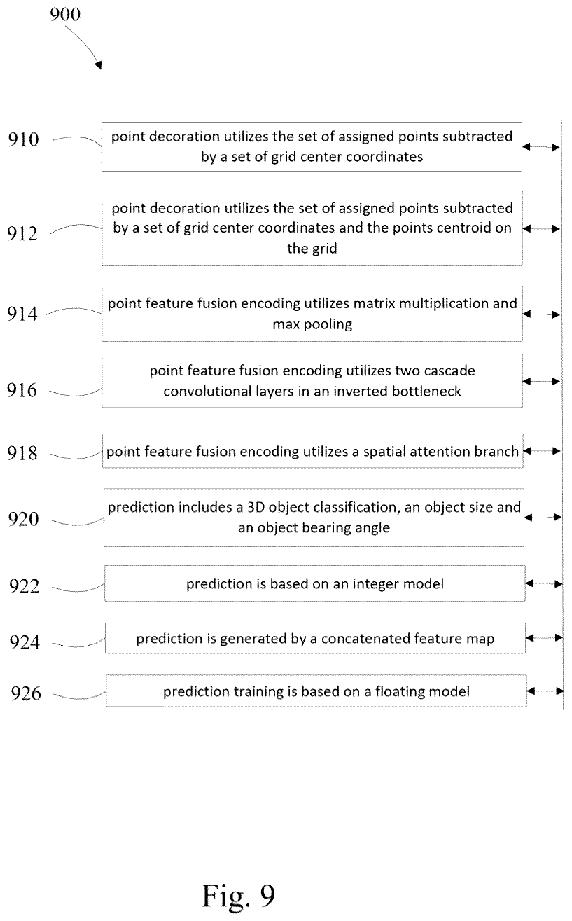

FIG. 9 900 depicts another example method the point decoration may utilize 910 the set of assigned points subtracted by a set of grid center coordinates or utilize 912 the set of assigned points subtracted by a set of grid center coordinates and the points centroid on the grid and the like. The point feature encoding may utilize 914 matrix multiplication and max pooling or utilize 916 two cascade convolutional layers in an inverted bottleneck or utilize 918 a spatial attention branch and the like. The prediction may include 920 a 3D object classification, an object size and an object bearing angle, the prediction may be based 922 on an integer model and may be generated 924 by a concatenated feature map and prediction training may be based 926 on a floating model.

In some embodiments, a computing apparatus comprises one or more non-transitory computer readable storage media, a processing system operatively coupled to the one or more non-transitory computer readable storage media, and program instructions stored on the one or more non-transitory computer readable storage media that, when executed by the processing system, direct the processing system to: (i) receive a point cloud having a set of irregular lidar points; (ii) assign the set of irregular lidar points to either a three-dimensional or two-dimensional grid thereby resulting in a set of assigned points; (iii) determine a pseudo image based on the set of assigned points thereby resulting in a set of regular pseudo image points; (iv) encode the set of regular pseudo image points via normalizing a reflection channel, decorating at least one point, and encoding the at least one point as a set of high dimension regular features; and (v) predict at least one three-dimensional object utilizing the set of high dimension regular features.

In some embodiments, a non-transitory computer readable storage media comprises program instructions that, when executed by a processing system, direct the processing system to: (i) receive a point cloud having a set of irregular lidar points; (ii) assign the set of irregular lidar points to either a three-dimensional or two-dimensional grid thereby resulting in a set of assigned points; (iii) determine a pseudo image based on the set of assigned points thereby resulting in a set of regular pseudo image points; (iv) encode the set of regular pseudo image points via normalizing a reflection channel, decorating at least one point, and encoding the at least one point as a set of high dimension regular features; and (v) predict at least one three-dimensional object utilizing the set of high dimension regular features.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the system. Skilled artisans may implement the described functionality in varying ways for each particular application. Various components and blocks may be arranged differently (e.g., arranged in a different order, or partitioned in a different way) without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects may be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code may be construed as a processor programmed to execute code or operable to execute code.

A phrase such as an “aspect” does not imply that such aspect is essential to the subject technology or that such aspect applies to configurations of the subject technology. A disclosure relating to an aspect may apply to configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to configurations of the subject technology. A disclosure relating to an embodiment may apply to embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to configurations of the subject technology. A disclosure relating to a configuration may apply to configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

Structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art may be able to design and incorporate any one of the variety of mechanisms suitable for accomplishing the above described functionalities.

It is to be understood that the disclosure teaches just one example of the illustrative embodiment and that many variations of the invention may easily be devised by those skilled in the art after reading this disclosure and that the scope of then present invention is to be determined by the following claims.

What is claimed is:

1. A method of detecting three-dimensional objects using lidar points, comprising:
receiving a point cloud having a set of irregular lidar points;
assigning the set of irregular lidar points to either a three-dimensional or two-dimensional grid thereby resulting in a set of assigned points;
determining a pseudo image based on the set of assigned points thereby resulting in a set of regular pseudo image points;
encoding the set of regular pseudo image points via normalizing a reflection channel, decorating at least one point, and encoding the at least one point as a set of high dimension regular features; and
predicting at least one three-dimensional object utilizing the set of high dimension regular features.

2. The method of claim 1, further comprising preprocessing the set of irregular lidar points to remove redundant operators.

3. The method of claim 1, further comprising postprocessing the at least one three-dimensional object to remove redundant operators.

4. The method of claim 1, further comprising filtering the set of irregular lidar points to a predefined detection range.

5. The method of claim 1, further comprising suppressing redundant points in the set of irregular lidar points.

6. The method of claim 1, further comprising transforming the set of irregular lidar points from a lidar coordinate frame to a camera coordinate frame.

7. The method of claim 1, further comprising determining two-dimensional point coordinates on an image plane by projecting three-dimensional coordinates onto a two-dimensional plane.

8. The method of claim 1, further comprising iterating the set of irregular lidar points to the set of regular pseudo image points within a predefined detection range.

9. The method of claim 1, wherein the point decoration utilizes the set of assigned points subtracted by a set of grid center coordinates.

10. The method of claim 1, wherein the point decoration utilizes the set of assigned points subtracted by a set of grid center coordinates and a centroid of the points on the grid.

11. The method of claim 1, wherein the point feature encoding utilizes matrix multiplication and max pooling.

12. The method of claim 1, wherein the point feature encoding utilizes two cascade convolutional layers in an inverted bottleneck.

13. The method of claim 1, wherein the point feature encoding utilizes a spatial attention branch.

14. The method of claim 1, wherein the prediction comprises a three-dimensional object classification, an object size, and an object bearing angle.

15. The method of claim 1, wherein the prediction is based on an integer model.

16. The method of claim 1, wherein the prediction is generated by a concatenated feature map.

17. The method of claim 1, wherein prediction training is based on a floating model.

18. The method of claim 1, wherein the method is performed on a system on a chip.

19. A computing apparatus comprising:
one or more non-transitory computer readable storage media;
a processing system operatively coupled to the one or more non-transitory computer readable storage media; and
program instructions stored on the one or more non-transitory computer readable storage media that, when executed by the processing system, direct the processing system to:
receive a point cloud having a set of irregular lidar points;
assign the set of irregular lidar points to either a three-dimensional or two-dimensional grid thereby resulting in a set of assigned points;
determine a pseudo image based on the set of assigned points thereby resulting in a set of regular pseudo image points;
encode the set of regular pseudo image points via normalizing a reflection channel, decorating at least one point, and encoding the at least one point as a set of high dimension regular features; and
predict at least one three-dimensional object utilizing the set of high dimension regular features.

20. A non-transitory computer readable storage media comprising:
program instructions that, when executed by a processing system, direct the processing system to:
receive a point cloud having a set of irregular lidar points;
assign the set of irregular lidar points to either a three-dimensional or two-dimensional grid thereby resulting in a set of assigned points;
determine a pseudo image based on the set of assigned points thereby resulting in a set of regular pseudo image points;
encode the set of regular pseudo image points via normalizing a reflection channel, decorating at least one point, and encoding the at least one point as a set of high dimension regular features; and
predict at least one three-dimensional object utilizing the set of high dimension regular features.
